(19) United States
(12) Patent Application Publication
(10) Pub. No.: US 2010/0242847 A1
(43) Pub. Date: Sep. 30, 2010

(54) Anchored pet feeder/waterer

(76) Inventor: Robby Gray, Charleston, IN (US)

Correspondence Address: David W. Carrithers;CARRITHERS LAW OFFICE, PLLC, Suite 206, 6200 Dutchmans Lane, Louisville, KY, 40205, US

(21) Appl. No.: 12/384,041

(22) Filed: Mar. 31, 2009

(51) Int. Cl. A01K 1/10

(52) U.S. Cl. 119/61.54

(57) ABSTRACT

A pet food bowl anchoring apparatus including a bowl having a horizontal bottom surface and a vertical wall attached to a peripheral edge of the bottom surface. The wall extending above the bottom surface forms a dish and the wall extending below the bottom surface forms a support wall portion holding the bottom surface above a floor surface onto which the bowl is resting. The support wall portion has is formed or machined to include a slot into which a user's fingers may be placed for picking the bowl up from the floor surface. A keeper connected loosely at a first end to a bottom surface of the bowl protrudes generally horizontally out of the slot exterior to the support wall portion. The keeper has formed therein two apertures, a first aperture in a central area of the keeper wherein a fastener loosely connects the keeper to the bowl, and a second aperture formed in a central area of the portion of the keeper protruding out from the support wall portion. A spring captured between the keeper and the bowl and surrounding the fastener biases the keeper away from the bowl. A vertical pin rigidly secures the keeper to the floor surface. The pin has the second aperture of the keeper pushed thereon so that a portion of an edge of the aperture achieves a friction fit against the pin, and wherein the protruding portion of the keeper may be raised, thus releasing the friction fit.

### BACKGROUND OF THE INVENTION

1. Field of the Invention

The invention relates generally to pet food and water containers. The invention relates more specifically to a pet food/water dish capable of withstanding spills, particularly of being overturned by tethers, pets, or being carried away by other animals, mainly dogs. This ability is obtained by a ground anchor, and an attaching apparatus that is located on the bottom of the pet dish.

2. Description of Related Art

Many households today have pets, mainly dogs, which are fed outside. In many cases, the pets end up overturning their food and/or water dishes by using their mouth, paws, tethers and/or the dish is carried away by another animal. The above problems are concerns and a nuisance for pet owners, not to mention a hot, thirsty, or hungry pet. In the past, anchored pet dish designs have been used with pet dishes in various ways.

Several references suggest various methods to anchor pet food bowls. For instance, U.S. Pat. No. 6,401,656 B1 (Adkisson) utilizes a large anchor with a horizontal surface across the top and a bowl on each end. U.S. Pat. No. D505,757 S (Wojcik et al.) is an anchor with two loops at the top that holds two bowls. U.S. Pat. No. 5,526,773 (Richardson) utilizes a base attached to the ground by a large screw type anchor then having a bowl sit in this base. U.S. Pat. No. 5,165,365 (Thompson) utilizes an anchor primarily for stabilizing and support of an elevated dining area and a swivel hoop to use a tether line or chain. U.S. Pat. No. 5,148,626 (Haake, Sr.) utilizes an anchor to prevent a protective cover for a feeder dish from being displaced. If there is no danger of displacement, the anchor may be omitted. U.S. Pat. No. 5,069,167 (Kasselman) features a pet feeder base that is receptive to an anchor device. The design features a water moat to deter crawling insects. U.S. Pat. No. 5,224,443 (Leslie) utilizes a spring hook anchor device to secure a food reservoir to either a slotted or meshed floor in an animal pen. U.S. Pat. No. 4,546,730 (Holland) utilizes an anchor device mainly to support an umbrella.

The anchor device of the present invention also functions to stabilize a feeding bowl. The bowl in turn helps ensure the anchor remains perpendicular in the ground. In the past, there have been many attempts to produce pet feeders/waterers that are resistant to spillage and unwanted movement. Despite these earlier designs, there still remains a need for a practical, inexpensive, pet feeder/waterer which solves this problem.

### SUMMARY OF THE INVENTION

The primary purpose of this invention is to provide a pet feeder/waterer which is resistant to spills, especially being overturned by the pet, pet's chain, and/or being carried away by your pet or other animals. This is accomplished by an anchor that is installed into the ground or by an anchor that is installed onto a hard surface such as a deck or concrete. A lever on the bottom of the feeder/waterer, contacts the anchor putting spring tension against the anchor, securing the feeder/waterer to the anchor and thus the feeder/waterer to the ground.

There is also a hard surface anchor. This anchor is a flat piece of metal with two screw holes for attaching to a deck or hard surface. There is an anchor that sticks up from the middle of this flat metal that the feeder/waterer attaches to, just like how the ground anchor attaches to the bowl.

These objectives are accomplished by the instant invention wherein a pet food bowl system comprises a bowl having a horizontal bottom surface and a vertical wall attached to a peripheral edge of a bottom, of the bowl. The wall extending above the bottom surface forms a dish and the wall extending below the bottom surface forms a support wall portion holding the bottom surface above a floor surface onto which the bowl is resting. The support wall portion has is formed or machined to include a slot into which a user's fingers may be placed for picking the bowl up from the floor surface. A keeper connected loosely at a first end to a bottom surface of the bowl protrudes generally horizontally out of the slot exterior to the support wall portion. The keeper has formed therein two apertures, a first aperture in a central area of the keeper wherein a fastener loosely connects the keeper to the bowl, and a second aperture formed in a central area of the portion of the keeper protruding out from the support wall portion. A spring captured between the keeper and the bowl and surrounding the fastener biases the keeper away from the bowl. A vertical pin rigidly secures the keeper to the floor surface. The pin has the second aperture of the keeper pushed thereon so that a portion of an edge of the aperture achieves a friction fit against the pin, and wherein the protruding portion of the keeper may be raised, thus releasing the friction fit.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a perspective view of the spill-free, unmovable, pet feeder/waterer dish of the present invention;

FIG. 2 is a bottom perspective view of the dish;

FIG. 3 is an enlarged perspective view of the anchor lever and lever components;

FIG. 4 is a perspective view of the ground anchor;

FIG. 5 is a perspective view of the hard surface anchor for attachment to hard surfaces like decks and concrete; and

FIG. 6 is a perspective view of a divided dish.

### DETAILED DESCRIPTION

The primary purpose of this invention is to provide a pet feeder/waterer which is resistant to spills, especially being overturned by the pet, pet's tether and/or being carried away by your pet or other animals. This is accomplished by an anchor, which is twisted (clockwise like a cork screw) into the ground until the horizontal section of the anchor contacts the ground. There is an approximately 1½ inch vertical anchor extension on top of the anchor. As you sit the feeder/waterer onto the anchor extension, the anchor extension enters through the anchor lever receiving hole (which is in the anchor lever on the bottom of the feeder/waterer) and into an anchor receiving cavity in the bottom of the feeder/waterer. Your hand placed on one end of the dish, compresses the anchor lever. Near the other end of this lever is means for applying spring tension such as a conventional spring type device that exerts downward force to the lever including coil spring, leaf spring, or other biasing means. The feeder/waterer is set onto the anchor with the anchor extension entering the anchor lever receiving hole through the anchor lever. The top of the anchor extension finally enters the anchor receiving cavity in the bottom of the feeder/waterer. As the feeder/waterer contacts the ground, you release the feeder/waterer, releasing the anchor lever at the same time. The lever being under spring tension, then contacts the side of the anchor extension, putting spring tension against the anchor, securing the feeder/waterer to the anchor that is screwed into the ground, and thus securing the feeder/waterer to the ground.

The top area of the hard surface anchor works the same way as the top of area of the ground anchor as far as attachment to the feeder/waterer.

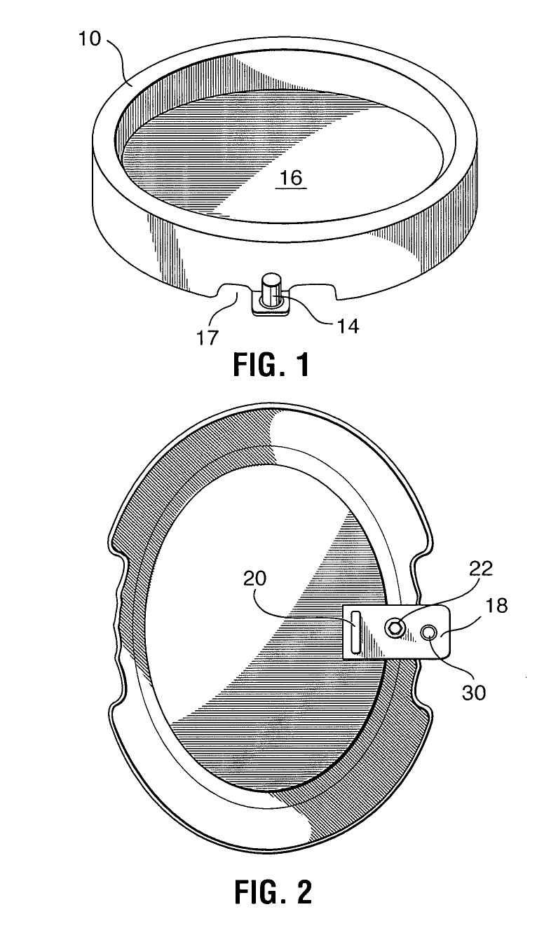

As shown in the drawings of FIGS. 1-6, the primary component is designated as the pet feeder/waterer (10). The pet feeder (10) includes the food or water receptacle (16), typical of such pet feeder/waterer configurations. The pet feeder (10) also incorporates handle apertures (17), on either side of the pet feeder (10), in a manner that allows the easy installation and removal of the pet feeder (10) from the ground anchor (14). The pet feeder (10) may be molded from semi-rigid plastic material or metal or a combination of plastic and metal.

FIG. 2 is a view of the bottom of the pet feeder (10) and its manner of attachment to the ground anchor (14). FIG. 2 discloses the location of the anchor release lever (18), anchor receiving hole (30), anchor lever mount (20) and anchor lever bolt (22).

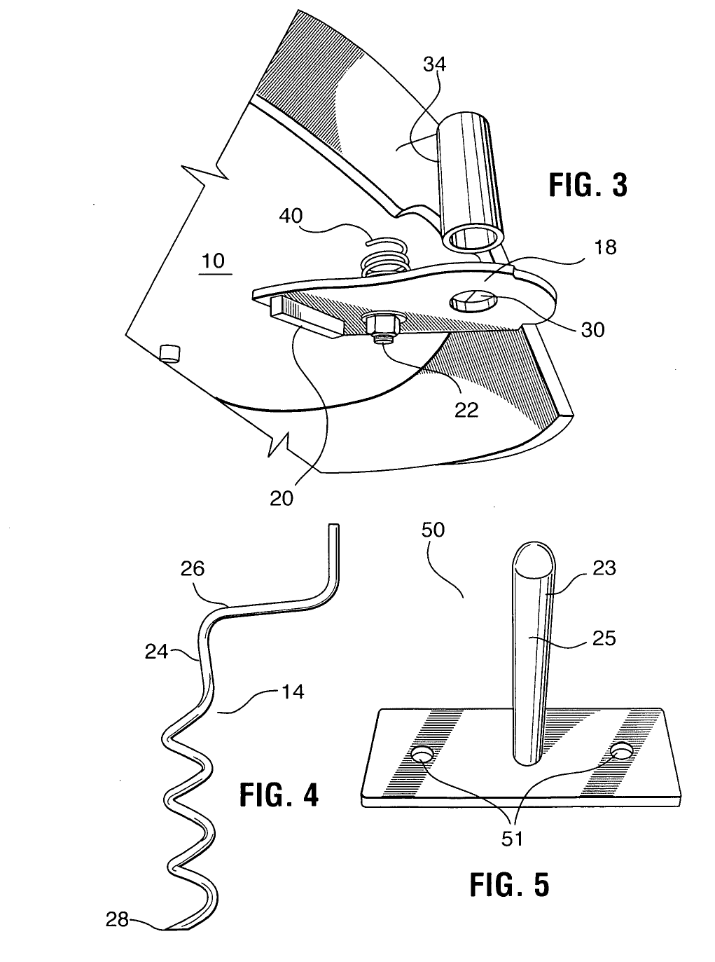

FIG. 3 is a closer view of the anchor release lever (18) and components. The anchor lever receiving hole (30) which is located in the anchor release lever (18). The anchor lever mount (20), for holding the anchor release lever (18) to the bottom of the pet feeder/waterer (10). The anchor basin (34), where the anchor top (23) goes into. A compression spring (40), for applying downward force to the anchor release lever (18), is located under the anchor release lever (18) and around the anchor lever bolt (22). This release lever spring (40) is applying downward force to the anchor release lever (18).

References now made to FIG. 4 for a detailed description of the structure of the ground anchor (14). In FIG. 4 the ground anchor (14) is shown as having a round metal shaft (24) for insertion into the ground. The ground anchor (14) is inserted into the ground by applying a downward force with your hand on the top of the anchor horizontal section (26) and turning the anchor in a clockwise (to the right) direction with the anchor point (28) entering the ground. Installation of ground anchor (14) is complete when the anchor horizontal section (26) contacts the ground.

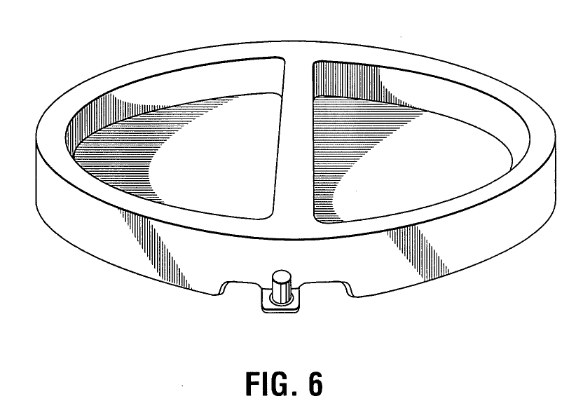

FIG. 5 is a view of the hard surface anchor (50). Screws are inserted through the screw holes (51) and into the hard surface of a deck or concrete or the like of, thus securing the hard surface anchor (50) to the hard surface. The anchor top (23) and the anchor side (25) is secured to the anchor release lever (18) as in the same manner as the ground anchor (14).

It will become obvious to those familiar in the art of spring tension devices that other embodiments such as flat spring steel or similar devices may be used instead of a compression spring (40). Also other similar catches may be employed.

After the ground anchor (14) is installed into the ground, the pet feeder (10) is set on top of the anchor top (23) with the anchor top (23) entering through the anchor receiving hole (30) and into the anchor basin (34). The anchor release lever (18), being under spring tension from the downward force from the release lever spring (40), is released (you remove your hand from the bowl) and contacts the anchor top side (25), putting spring tension against the anchor top side (25) thus connecting the anchor release lever (18) to the anchor top side (25) and thus to the earth.

If your pet is on a tether, you can also install this invention close to the end of the pets tether travel. Thus allowing a person to fill the dish but the animal will not be able to jump up onto the person. No longer will the neighbor's dog take your dogs' dish (bowl). You will always know where your pets dish is, no need to go looking for it in your yard, or your neighbors yard or the neighborhood.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

I claim:

1. A pet food bowl system comprising:
a bowl having a horizontal bottom surface and a vertical wall attached to a peripheral edge of said bottom, said wall extending above said bottom surface forming a dish and said wall extending below said bottom surface forming a support wall portion holding said bottom surface above a floor surface onto which said bowl is resting;
said support wall portion having an amount removed forming a slot into which a user's fingers may be placed for picking said bowl up from said floor surface;
a keeper connected loosely at a first end to a bottom surface of said bowl and protruding roughly horizontally out of said slot and exterior to said support wall portion, said keeper having formed therein two apertures, a first aperture in a central area of said keeper wherein a fastener loosely connects said keeper to said bowl, and a second aperture formed in a central area of said portion of said keeper protruding out from said support wall portion;
a spring captured between said keeper and said bowl and surrounding said fastener biasing said keeper away from said bowl;
a vertical pin rigidly secured to said floor surface, said pin having said second aperture of said keeper pushed thereon, a portion of an edge of said aperture achieving a friction fit against said pin, and wherein said protruding portion of said keeper may be raised, thus releasing said friction fit.

2. The pet food bowl system defined in claim 1 wherein a cover comprising a cylinder enclosed on a top end and having its open end affixed to said keeper covering said second aperture of said keeper and said pin when said bowl is held in place by said pin.

3. The pet food bowl system defined in claim I wherein said vertical pin is a part of a handle connected to a helical coil having a point formed at a bottom tip for screwing into soil or any soft surface for the purpose of securing said pin.

4. The pet food bowl system defined in claim 1 wherein said vertical pin is rigidly affixed to a horizontal plate containing at least two apertures for the purpose of fastening said plate and said pin to a hard flooring surface.
